(19) United States
(12) Patent Application Publication
(10) Pub. No.: US 2010/0315390 A1
(43) Pub. Date: Dec. 16, 2010

(54) APPARATUS FOR OBJECT PRESENTATIONS CONTAINING AN ELECTRONIC DISPLAY SYSTEM

(75) Inventors: Anthonie Hendrik Bergman, Nuenen (NL); Bartel Marinus Van De Sluis, Eindhoven (NL); Theodorus Johannes Petrus Van Den Biggelaar, Veldhoven (NL); Henriette Christine Marie Hoonhout, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/867,892

(22) PCT Filed: Jan. 20, 2009
(86) PCT No.: PCT/IB09/50191

§ 371 Date: Aug. 17, 2010

(30) Foreign Application Priority Data
Feb. 20, 2008 (EP) 08101801.2

(51) Int. Cl. G09G 5/00

(52) U.S. Cl. 345/204

(57) ABSTRACT

The invention relates to an apparatus for object presentations by means of an electronic display system, such as a shelf with an integrated lighting system for illuminating objects positioned on a surface of the shelf in order to create appealing object presentations for example in shops, museums or homes. A basic idea of this invention is to integrate a display system such as a lighting system into a presentation device for quickly and easily creating a decoration effect such as a light effect for attracting people. The invention provides in an embodiment an apparatus (10) for object presentations comprising a presentation device (12) with a surface (14) to display an object (16) being placed on the surface, and an electronic display system (18) being integrated in the presentation device and adapted to create a decoration effect (20) on the surface. By integrating the display system in the presentation device, on which an object to be presented may be placed, the decoration effect is created from the bottom, i.e. from below the object, and, thus, does not require as much space as a decoration effect from above the object may require.

### FIELD OF THE INVENTION

The invention relates to an apparatus for object presentations by means of an electronic display system, such as a shelf board with an integrated lighting system for illuminating objects positioned on a surface of the shelf board in order to create appealing object presentations for example in shops, museums or homes.

### BACKGROUND OF THE INVENTION

Shops want to bring products under shoppers' attention in an elegant and subtle way. Especially stores for fashion and luxury products in the mid and higher retail segment are willing to invest in making the most appealing product presentations. For instance, they may use particular decorations such as colors, patterns or materials in order to attract the shopper's attention and make the products look attractive. However, updating and adapting the decoration to ever faster changing collections is costly and often creates a hassle, which is undesirable.

### SUMMARY OF THE INVENTION

It is an object of the present invention to provide an apparatus for object presentations, which allows to quickly and easily creating a decoration effect for an object presentation.

The object is solved by the independent claims. Further embodiments are shown by the dependent claims.

A basic idea of this invention is to integrate a display system such as a lighting system into a presentation device for quickly and easily creating a decoration effect such as a light effect for attracting people. By integrating the display system in the presentation device, on which an object to be presented may be placed, the decoration effect is created from the bottom, i.e. from below the object, and, thus, does not require as much space as a decoration effect from above the object may require. This allows to saving space particularly retail space, which would be required for complex display systems creating a display effect from above of the object. Furthermore, the invention makes it possible to create a local and compact decoration effect in a quick and easy way.

An embodiment of the invention provides an apparatus for object presentations comprising
a presentation device with a surface to display an object being placed on the surface, and
an electronic display system being integrated in the presentation device and adapted to create a decoration effect on the surface.

The integrated electronic display system does not require space above an object to be presented and allows creating a decoration effect such as for example an appealing and eye-catching light effect. For example, the decoration effect may be lighting comprising rings of colored light, surrounding the object to be presented.

According to a further embodiment of the invention,
the presentation device may be a shelf board and
the surface may be formed by at least a part of one side of the shelf board, wherein the part is at least partly translucent.

Such a shelf board may be for example used in product presentation shelves as used in shops, museums or homes.

In a further embodiment of the invention, the electronic display system may comprise
an illumination system being integrated in the presentation device below the surface and adapted to create a light effect on the surface by illuminating the surface from inside the presentation device.

The illumination system may comprise for example color or RGB (Red Green Blue) LEDs for creating colored light effects.

The illumination system may comprise in a further embodiment of the invention
one or more concentrically arranged circular light guides and
a lighting unit arranged such that light created by the light unit is guided by the circular light guides.

The light guides may be implemented by grooves of the presentation device. The lighting unit may be for example a PCB (Printed Circuit Board) containing LEDs. The PCB may be mounted in a recess of the presentation device such that the LEDs are coupled to the light guides.

According to a further embodiment of the invention, a pattern of dots may be spread over the surface, wherein each dot is provided for coupling out a fraction of light from a circular light guide. The dots serve as a kind of micro light sources on the surface on which the object to be presented may be placed. Dots have the advantage that they may be mechanically brought into the presentation device and do not require a dedicated material, which is translucent for light.

The lighting unit may according to a further embodiment of the invention comprise separate light sources for each circular light guide. Thus, it is possible to create several light circles with different light effects on the surface of the presentation device, for example a red, green, blue light circle concentrically arranged with an object to be presented in the middle of all circles.

Each light source may comprise at least one RGB LED, according to a further embodiment of the invention. This allows to create different color light effects in each circular light guide.

According to a further embodiment of the invention, the apparatus may comprise
at least one sensor integrated in the presentation device near the surface for detecting an object being placed on the surface and
a control unit being adapted for controlling the display system depending on the output of the at least one sensor.

This allows adapting the generated display effect to the detected object. For example, if no object is detected, the display effect may be disabled or switched to a predefined effect showing that actually no object is presented, for example a text like “coming soon”.

According to a further embodiment of the invention,
several object sensors may be provided for detecting the presence and approximate size of an object being placed on the surface, and
the control unit may be adapted to process the outputs of the object sensors and to adapt the decoration effect to the approximate size of the object.

This allows adapted the display effect to the kind of detected object. For example, if a large object is detected, the display effect may be larger such as light circles with a larger diameter in order to surround the detected object in contrast to a smaller object, which may cause an adoption of the display effect for example to smaller light circles.

According to a further embodiment of the invention,
several object sensors may be provided for detecting the position and approximate shape of an object being placed on the surface, and
the control unit may be adapted to process the outputs of the object sensors and to adapt the decoration effect to the position and approximate shape of the object.

Especially when a LCD display technology is used as electronic display system, the adapting of the position and shape of the display effect becomes much more flexible.

According to a further embodiment of the invention,
at least one color sensor may be provided for detecting the color of an object being placed on the surface, and
the control unit may be adapted to process the output of the at least one color sensor and to adapt the color of the decoration effect to the detected color of the object.

This allows adapting the color of the decoration effect to the object's color, for example to create a red colored decoration effect for a blue object. It would also be possible to dynamically adapt the color of the decoration effect, for example the color could change from red to blue and vice versa.

In a further embodiment of the invention,
at least one presence sensor may be provided for detecting the presence of a person, and
the control unit may be adapted to process the output of the at least one presence sensor and to adapt the decoration effect to the detected presence of the person.

With this embodiment, the decoration effect may be for example activated on a detected presence of a person, or switched from static to dynamic in order to attract the person's interest to the presented object.

The invention relates in a further embodiment to an article of furniture comprising an apparatus for object presentations according to the invention and as described above.

Finally, an embodiment of the invention relates to the usage of an apparatus for object presentations according to the invention and as described above in a shop, museum, home or place, where objects are presented in a people attracting way.

### BRIEF DESCRIPTION OF THE DRAWINGS

These and other aspects of the invention will be apparent from and elucidated with reference to the embodiments described hereinafter.

The invention will be described in more detail hereinafter with reference to exemplary embodiments. However, the invention is not limited to these exemplary embodiments.

FIG. 1 shows in a perspective view a shelf board for object presentations according to an embodiment of the invention;

FIG. 2 shows the bottom side of a shelf board from FIG. 1; and

FIG. 3 shows the top side of the shelf board from FIG. 1.

### DETAILED DESCRIPTION OF EMBODIMENTS

In the following, functionally similar or identical elements may have the same reference numerals.

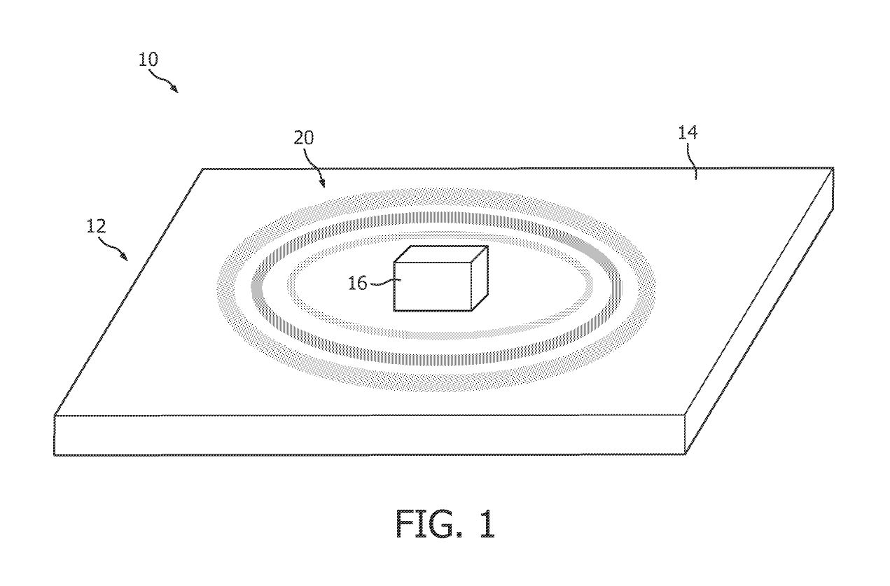

FIG. 1 shows as an apparatus 10 for object presentations a shelf board 12 for product presentations, as it may be used by retailers for appealing product presentations such as colored decoration close to or around a product. The product 16 to be presented may be placed on the surface 14 of the shelf board 12. The shelf board 12 is able to create light effect 20 such as a white accent light from below the product itself as well as colored light on the surface 14 around the product. The inventors found that such a light effect for product presentation was well received by shoppers and fashion retailers who liked the appealing and eye-catching effect. The advantage of creating a light effect from below is that it requires less space than an illumination from above the product for example with a spot light. The light effect 20 generated by the apparatus 10 may be one or more colored rings around the product 16, which is located inside the rings. A further accent or white light may be created directly under the product 16 in order to enlighten the product 16. The invention does create the light effect 20 not by illuminating the surface 14 of the shelf board 12 from above, but it creates the light effect inside the surface 14 the product 16 is sitting on, thus allowing to save space and to create a local light effect. Thus, even if an accent lighting on the product 16 itself will still be done from above in order to achieve an optimal and natural light effect on the product, a light spot with a narrow beam in order to appropriately illuminate the product while not shining too much white light on the colored rings in order to keep their effect would suffice and save space.

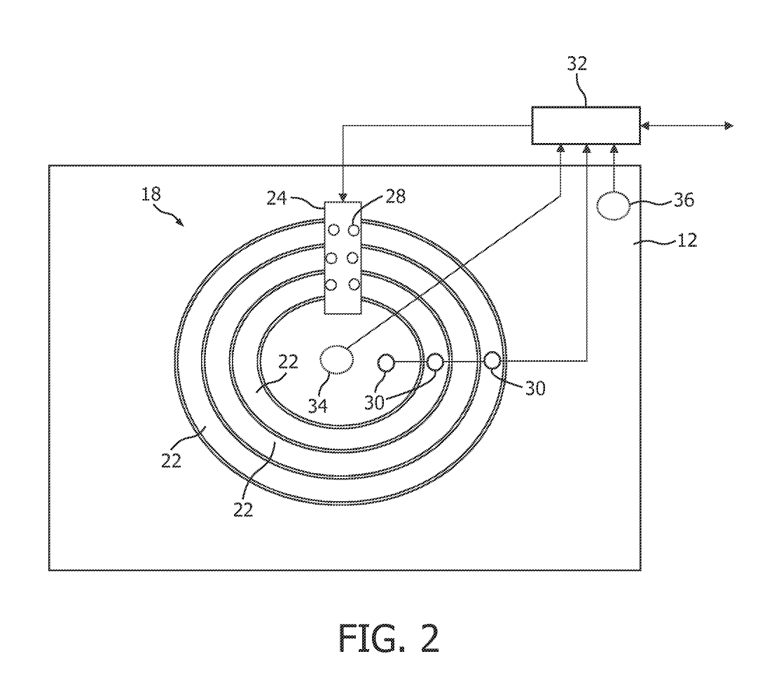

FIG. 2 shows the bottom side of the shelf board 12 and the illumination system 18 for creating the light effect on the surface 14 of the shelf board 12 in detail. The illumination system 18 comprises several concentrically arranged circular light guides 22 and a lighting unit 24. The light guides 22 are quite broad with limited space between them. The light guides 22 each contains a cut-away or recess in the bottom side of the shelf board 12 allowing space for the a PCB implementing the lighting unit 24, which contains small RGB LEDs 28 at both sides in order to couple light in two directions into the circular light guides 22. The small RGB LEDs 28 on the PCB may be positioned in a slid in a circle of a thin plate of PMMA (Polymethylmethacrylate). The light of a RGB LED is captured in the plate and is kept inside by Total Internal Reflection (TIR). Depending on the width of the circular light guides 22, also several LEDs 28 such as three may be provided for each light guide 22 in order to couple enough light into the light guides 22 for creating light effects with sufficient brightness.

Furthermore, FIG. 2 shows that on the bottom side of the shelf board 12 several sensors 30 for determining the size of the product to be presented are arranged between the circular light guides 22. The output signals of the sensors 30 are received by a control unit together with output signals from a color sensor 34 for detecting the color of the product and a presence sensor 36 for detecting the presence of people, for example in front of a shelf containing the shelf board 12. The control unit 32 may not necessarily be integrated in the shelf board, but also externally arranged to it.

The control unit 32 comprises a processor for processing the received sensor signals and to control the RGB LEDs 28 of the lighting unit 24 responsive to the received sensor signals. For example, the processor may be configured for automatically adapting the light effect created on the surface 14 of the shelf board to the size and appearance of the product presented. In addition the decoration may be responsive to the presence, detected interest or actions of people (shoppers) nearby. This functionality will be described later.

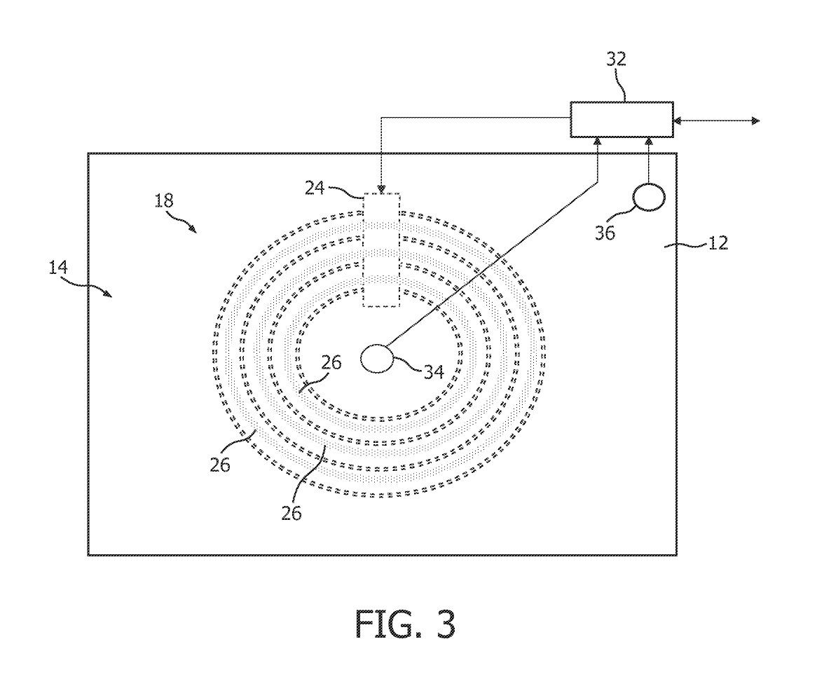

FIG. 3 shows the top side of the shelf board 12. The position of the lighting unit 24 integrated in the shelf board 12 is shown by dotted lines. The surface 14 of the shelf board 12 is on the top side at least partly translucent, i.e. light can discharge from the circular light guides 22 through the surface 14 in order to create the desired light effect 20 on the top side of the shelf board. The translucency may be achieved by means of patterns 26 of dots. The patterns 26 of dots may be spread over the surface 14 of the board 12. Each dot couples out a fraction of the light guided in the circular light guides 22. The patterns 26 may be made such that the amount of light coupled out is roughly homogeneous over the whole surface 14. This may be achieved by balancing the amount of “trapped” light (highest near the RGB LEDS 28 of the lighting unit 24) and the surface density of the dots. The surface area of the dots can be varied by changing the amount of dots or the size of the dots.

An auto-adaptation function of the created light effect to the presented product as mentioned above will be described now in detail. Such a functionality has the advantage that for example fashion retailers, who update their fashion collections very often, do not have to manually adapt the decoration elements in the store to the merchandise presented, since the invention allows an automatic adaptation with one or more of the sensors 30, 34, and 36 integrated in the shelf board 12. Typical auto-adaptations are for example as follows:
Adapt the light effect size to the object size: the sensors 30, which may be for example implemented as pressure or light sensors, are applied to detect both the presence and the approximate size of an object. In response to the signals of the sensors 30, the processor of the control unit 32 may be configured to automatically adjust the size of the light effect rings to the size of the object, for example by activating not all but only some of the RGB LEDs 28 of the lighting unit 24 in order to illuminate only some of the multiple concentric circular light guides 22 (typically, the processor selects the circular light guide 22, which has a diameter somewhat larger than the object size detected).
Adapt color of the light effect to object color: one or multiple color sensors 34 may be integrated in the (center of the) shelf board 12 and are applied to measure one or more colors in (the bottom of) an object. In response to the signals of the sensor 34, the processor of the control unit 32 may be configured to automatically adjust the color to one or two matching colors of the light effect rings. For instance, the processor could control the lighting unit 24 such that it creates a light effect with the same color of the object or contrasting or nicely matching color.
Adapt the dynamics of the light effect to the presence of people: one or more presence sensors 36 may be integrated in the shelf board 12 and are applied to detect the presence of or distance to people or people's actions, for example whether people approach a shelf containing the shelf board 12, whether people are already standing in front of a shelf containing the shelf board 12, or whether people are pointing to the object. In response to the signals of the sensor 36, the processor of the control unit 32 may be configured to automatically adjust the dynamics of the light effect rings. This helps to attracting attention and to make the light effect responsive to user actions

The last auto-adaptation functionality may serve to attract attention of people. The processor may execute several different programs in order to attract attention, as will be described in detail in the following. It should be noted that the programs may be implemented in software and stored in a memory of the control unit, but it is also possible to implement the functionality of the processor and the programs in hardware.

1. Changing Intensity of the Light Effect
Approaching: when a shopper approaches the shelf, the intensity of the light effect rings could be (gradually) increased by the control unit 32.

2. Changing Color of the Light Effect
Instead of just changing or in addition to changing the intensity, the control unit 32 can easily change the color by respectively controlling the RGB LEDs 28 of the lighting unit 24.

3. Moving Color of the Light Effect
As shown in FIG. 2, on the PCB of the lighting unit 24, RGB LEDs 24 at both ends of a circular light guide 22 may be provided, so circular light guide 22 can be illuminated quite homogeneously. If the control unit 32 controls the RGB LEDs 28 at both ends of the same circular light guide 22 such that different colors on both ends are created, a color gradient can be obtained in the circular light guide 22. If the control unit 32 changes the two colors gradually human perception will pick a color change that seems most dominant. The position of this leading color change will seem to move gradually as the colors are changed. Experiments done so far show that if the two colors are opposite a ‘hue circle’ this effect is quite impressive. This astonishing effect gives the impression of a high resolution of RGB LEDs beneath the surface 14 of the shelf board 12 while in fact this result can be achieved by, in principle, just two RGB LEDs.

4. “Breathing” Light Effect Rings
In an embodiment with multiple concentric circular light guides, which allow to create multiple concentric light effect rings on the surface 14 of the shelf board, the control unit 32 can turn circles on and off in a predetermined sequence. This could give the illusion of breathing or a heart beat. This will certainly attract attentions as the visual system of human beings is very sensitive to movement.

5. Picking Up a Product:
When a shopper picks up the product from the shelf board 12, the control unit 32 can gradually fade out the light effect rings. When the product is put on the shelf board 12 again, the control unit 32 can gradually switch on the light effect rings, or it can create a pulsating light effect. If a more fancy effect is desired, the control unit 32 may also sequentially switch to smaller light effects rings when the product is picked up, and switch from small to large light effect rings sequentially when product is put back.

6. Feedback for Selection Interaction
The described reactions are also very suited for a feedback mechanism for an interaction with the goal of selecting a particular item out a range multiple products for more information. For instance, the example described at embodiment 2 above can be easily used to help select for example a particular mobile phone from a shelf containing several mobile phones. The control unit 32 may receive from the presence sensor 36 signals detecting shopper's gestures such as pointing to the particular phone in the shelf. In response to the sensor signals, the control unit 32 can for example change the color of the light effect created below the particular mobile phone, to which the shopper points and to output a signal for example to an external information display system about the selected mobile phone. This allows to display information of the selected phone on a video display of the external display system. The selection can be also facilitated by changing the color of light effect created under the item at which for instance a finger of the shopper is pointing for example to red. The shopper will see this reaction and understand the selection process. Moreover, after the selection is done and the information is shown, it is very clear to which mobile phone the information belongs: only one phone resides in a red circle while the others are surrounded by for example green circles.

Instead of lighting, also electronic displays may be integrated in the shelf board 12 in order to create decoration patterns around the product. For example, a LCD (Liquid Crystal Display) or LED display may be integrated. These electronic displays may be for example arranged below a translucent plate in respective recesses on the bottom side of the shelf board 12. The advantage of electronic display is the variety of possible decoration effects, which may not only be light effects but also for example pictures or texts.

Besides applications in shops, the invention may also be interesting for museums, or in the home or any other place where there is a need to present objects in an appealing way. In the shop environment the invention can also be applied in an intelligent shop window especially as an attractive way to give feedback to shoppers on products which are selected by means of pointing or gaze interaction.

At least some of the functionality of the invention may be performed by hard- or software. In case of an implementation in software, a single or multiple standard microprocessors or microcontrollers may be used to process a single or multiple algorithms implementing the invention.

It should be noted that the word “comprise” does not exclude other elements or steps, and that the word “a” or “an” does not exclude a plurality. Furthermore, any reference signs in the claims shall not be construed as limiting the scope of the invention.

1. Apparatus (10) for object presentations comprising
a presentation device having a surface for displaying an object being placed on the surface, and
an electronic display system being integrated in the presentation device and adapted to create a decoration effect on the surface.

2. The apparatus of claim 1, wherein
the presentation device is a shelf board and
the surface is formed by at least a part of one side of the shelf board, wherein the part is at least partly translucent.

3. The apparatus of claim 1, wherein the electronic display system comprises
an illumination system being integrated in the presentation device below the surface and adapted to create a light effect on the surface by illuminating the surface from inside the presentation device.

4. The apparatus of claim 3, wherein the illumination system comprises
one or more concentrically arranged circular light guides and
a lighting unit arranged such that light created by the light unit is guided by the circular light guides.

5. The apparatus of claim 4, wherein a pattern of dots is spread over the surface, wherein each dot is provided for coupling out a fraction of light from a circular light guide.

6. The apparatus of claim 4, wherein the lighting unit comprises separate light sources for each circular light guide.

7. The apparatus of claim 6, wherein each light source comprises at least one RGB LED.

8. The apparatus of claim 1, further comprising
at least one sensor integrated in the presentation device near the surface for detecting an object being placed on the surface and
a control unit being adapted for controlling the display system depending on the output of the at least one sensor.

9. The apparatus of claim 8, wherein
several object sensors are provided for detecting the presence and approximate size of an object being placed on the surface, and
the control unit is adapted to process the outputs of the object sensors and to alter the decoration effect based on the approximate size of the object.

10. The apparatus of claim 8, wherein
several object sensors are provided for detecting the position and approximate shape of an object being placed on the surface, and
the control unit is adapted to process the outputs of the object sensors and to alter the decoration effect based on the position and approximate shape of the object.

11. The apparatus of claim 8, wherein
at least one color sensor is provided for detecting the color of an object being placed on the surface, and
the control unit is adapted to process the output of the at least one color sensor and to alter the color of the decoration effect based on the detected color of the object.

12. The apparatus of claim 8, wherein
at least one presence sensor is provided for detecting the presence of a person, and
the control unit is adapted to process the output of the at least one presence sensor and to adapt the decoration effect to the detected presence of the person.

13-14. (canceled)
